(19) United States
(12) Patent Application Publication
(10) Pub. No.: US 2015/0049505 A1
(43) Pub. Date: Feb. 19, 2015

(54) TRANSPARENT LIGHT GUIDE

(71) Applicant: Garmin Switzerland GmbH, Schaffhausen (CH)

(72) Inventors: Zongkai Wang, Olathe, KS (US); Yu-San Lee, New Taipei City (TW); Benjamin E. Morrill, Overland Park, KS (US); Chun-Chao Tsui, Kaohsiung City (TW); Tyler H. Van Slyke, Olathe, KS (US)

(21) Appl. No.: 14/323,854

(22) Filed: Jul. 3, 2014

Related U.S. Application Data
(60) Provisional application No. 61/865,972, filed on Aug. 14, 2013.

(51) Int. Cl. F21V 8/00

(52) U.S. Cl. CPC G02B 6/0053
USPC 362/603

(57) ABSTRACT

A light guide for illuminating a mobile electronic device display. The light guide includes a light source, a light guide panel element having a light input surface located to receive light and a light output surface located proximate to a display active area, and a light guide ring surrounding the light guide panel element and having at least one end located proximate to the light source. The light guide ring may be shaped such that a significant portion of light enters the end(s) of the light guide ring and moves through it around the light guide panel element. A portion of the light moves into the light input surface of the light guide panel element and is redirected out the light output surface toward the display, thereby illuminating it the display with increased efficiency and uniformity. The light guide panel element may be transparent and positioned above or below the display.

### CROSS-REFERENCE TO RELATED APPLICATIONS

The present application claims the benefit of 35 U.S.C. §119(e) of U.S. Provisional Application Ser. No. 61/865,972, filed Aug. 14, 2013, and titled “FRONT LIGHT GUIDE FOR WATCH,” which is herein incorporated by reference in its entirety.

### BACKGROUND

Many electronic devices include an illumination feature to enhance the visibility of an area of a display. Some electronic devices utilize a highly opaque backlight that is positioned under a display to reflect light through the display to illuminate the display. An efficient opaque backlight is non-transparent and reflective to direct light through the display. A conventional opaque backlight utilizes diffuser and optical films to generate a uniform illumination of the display and reduce effects of hotspots. Other electronic devices utilize a transparent frontlight light guide positioned over a display to illuminate the display. Frontlight light guides cannot utilize diffuser films that limit visibility. As a result, conventional frontlight light guides include a first region that is positioned over a display and a second, light diffusion region in which one or more light sources generate light to illuminate the frontlight light guide and display. The area of the light diffusion region in the conventional frontlight light guide must be of sufficient width to diffuse the light generated by the light sources to provide a more uniform illumination of the first region positioned over the display. A housing that encloses the conventional frontlight light guide must utilize a bezel of sufficient width to account for the light diffusion region.

### SUMMARY

A light guide for illuminating a mobile electronic display active area. The light guide includes a light source, a light guide panel element having a light input surface located to receive light and a light output surface located proximate to the display active area, and a light guide ring surrounding the light guide panel element and having at least one end located proximate to the light source. The light guide ring is shaped such that a significant portion of light from the light source enters the end(s) of the light guide ring and moves through it around the light guide panel element, and a portion of the light moving through the light guide ring moves into the light input surface of the light guide panel element and is redirected out the light output surface toward the display active area. The light guide may illuminate the display active area with increased efficiency, uniformity, and shorter distance between light source and display active area. Microstructures in the light guide panel element may redirect the light toward the display active area. The light guide panel element may be transparent. The light guide panel element may be positioned above or below the display active area. The light guide panel element may be circular, polygonal, or any other suitable shape and the light guide ring substantially surrounding the light guide panel element may be annular or have any shape with a polygonal inner wall to surround the light guide panel element.

This Summary is provided solely to introduce subject matter that is fully described in the Detailed Description and Drawings. This Summary is not intended to identify key or essential features of the claimed subject matter, nor is it intended to be used as an aid in determining the scope of the claimed subject matter.

### BRIEF DESCRIPTION OF THE DRAWINGS

The Detailed Description refers to the accompanying figures. The use of the same reference numbers in different instances in the description and the figures may indicate similar or identical features.

FIG. 1 is an isometric view of an example first implementation of a mobile electronic device into which the light guide may be incorporated;

FIG. 2 is a top view of the device of FIG. 1, which is partially cut-away to show a display component in relation to the light guide;

FIG. 3 is an isometric view of a housing portion of the device of FIG. 1, which is partially cut-away to show various internal components;

FIG. 4 is a block diagram of various components of the device of FIG. 1;

FIG. 5 is an exploded view of the light guide of the device of FIG. 1;

FIG. 6 is an unexploded view of the light guide of the device of FIG. 1;

FIG. 7 is a fragmentary isometric view of the light guide of the device of FIG. 1, wherein arrows illustrate the movement of light within and from the light guide;

FIG. 8 is a cross-sectional isometric view of the light guide in which a light guide ring component has a wedge-shaped cross-section and a plurality of unequally spaced relief structures;

FIG. 9 is an isometric view of the light guide of FIG. 8;

FIG. 10 is an elevation view of the light guide of FIG. 8;

FIG. 11 is a fragmentary cross-sectional elevation view of the light guide having a first microstructure, wherein arrows illustrate the effect of the microstructure on light;

FIG. 12 is a fragmentary cross-sectional elevation view of the light guide having a second microstructure, wherein arrows illustrate the effect of the microstructure on light;

FIG. 13 is a fragmentary cross-sectional elevation view of the light guide having a third microstructure, wherein arrows illustrate the effect of the microstructure on light;

FIG. 14 is a fragmentary cross-sectional isometric view of the light guide having a gap between a light source component and a light guide ring component;

FIG. 15 is a top view of an example second implementation of the mobile electronic device, which is partially cut-away to show a display component in relation to the light guide;

FIG. 16 is a fragmentary isometric view of the light guide of the device of FIG. 15 having a substantially polygonal shape, wherein arrows illustrate the movement of light within the light guide; and

FIG. 17 is a cross-sectional elevation view of the light guide positioned between a display component and a covering component.

FIG. 18 is an isometric view of the light guide of the device of FIG. 1.

FIG. 19 is a fragmentary cross-sectional elevation view of the light guide having a plurality of microstructures, wherein arrows illustrate the effect of the microstructures on light.

FIG. 20 is a cross-sectional elevation view of the light guide positioned below a display component and a covering component.

### DETAILED DESCRIPTION

### Overview

Conventional highly opaque backlights that are positioned under a display to illuminate the display typically have a light guide panel with a reflective bottom surface that directs light towards the display. One or more light sources may be positioned adjacent to or under the light guide panel. Conventional, non-transparent backlights may account for hotspots by using diffuser and optical films because there is nothing behind the light guide panel for the user to view. The conventional backlights may include a plurality of elements, such as a reflector, light guide panel, diffuser, and one or more films, that individually or collectively provide the opaque, non-transparent surface to direct light through the display.

Alternatively, many electronic devices illuminate displays from the front of the display (on the side that is closer to the user's eyes) in environments having limited ambient light. The illumination of these conventional devices, such as devices including reflective liquid crystal display (LCDs) or e-paper displays, includes a frontlight that directs light, such as might be provided by one or more light emitting diodes (LEDs), towards a light guide panel positioned above the display active area of a display presenting content for a user. The conventional frontlight light guide may include hot spots (glare spots) on the frontlight light guide near each of the one or more light sources, which would result in non-uniform illumination if the hot spots are not accounted for. Conventional frontlight light guides include a first region that is positioned over a display and a second, light diffusion region having one or more light sources that generate light to illuminate the frontlight light guide and the hotspots associated with each of light source. The second, light diffusion region is typically concealed by a bezel to cover the hot spots. Conventional frontlight light guides commonly use microstructures on a light guide panel to aid with the uniform illumination of a display. For example, a conventional light guide panel may use low density of microstructures near a light source and higher density of microstructures in areas distant from the light source.

Conventional devices having a frontlight light guide typically include a bezel of increased width, for example 12 mm or wider, that is sufficient to cover the second, light diffusion region. The larger bezel increases the overall dimensions of the housing. Other conventional frontlight light guides may include a light guide pipe or a light bar positioned on one side of a light guide panel that is positioned above the display active area of a display. Similar to frontlight light guides having a second, light diffusion region, the light guide pipes and bars typically result in a hotspot near the light source that must be accounted for to provide uniform lighting. For instance, microstructures may be used to reduce any hotspots and other non-uniform light output.

In embodiments of the present invention, illumination of a display may be accomplished with a light guide ring surrounding the perimeter of a light guide panel element positioned either above or under a display to illuminate a display active area. The light guide ring may receive light from a light source that is positioned adjacent to the light guide ring and light guide panel. The light may be received perpendicular to the ring structure, parallel to the ring structure, or any other angle to uniformly illuminate the light guide ring and light guide panel. Light received from the light source leaves the light guide ring and enters a transparent light guide panel element that illuminates a display active area including content presented to a user. Unlike conventional opaque backlights, a transparent light guide panel element may be positioned above a display active area in a mobile electronic device while maintaining the visibility of content presented in the display active area. The light guide may be utilized in devices having a housing of limited size. For instance, the light guide may be used in a housing having a bezel of reduced width. The housing may be used for a watch device, tablet or computing device, or any other mobile electronic device.

A transparent light guide panel element may allow at least some of the light that enters the light guide panel element to exit the light guide panel element. It does not block light or significantly reduce the ability of a user to perceive information or objects present on the other side of the light guide panel element. Similarly, a transparent display does not block light or significantly reduce the ability of a user to perceive information or objects present on the other side of the display. Rather, the transparent light guide panel element and the transparent display may have limited reflectivity of light and enable a user to see through and recognize the information or objects present on the other side of either element. It should be understood that an element described herein as transparent may have low translucency and/or low opacity.

Transparency may be expressed as a ratio or percentage of light exiting the component to light entering the component. In embodiments of the present invention, the transparency of the transparent light guide panel element may range from 70% to 90%. The transparency of the transparent display may range from 10% to 50%. The transparent light guide panel element and/or the transparent display may be slightly tinted. The materials from which the light guide panel element may be formed include polycarbonate and polymethylmethacrylate.

In embodiments, the display active area of the display may be transparent. Utilizing the light guide disclosed herein, a user may be able to illuminate a display active area and view the displayed content and/or objects located on the other side of the light guide panel element and the display. For example, the light guide may illuminate a transparent display device in an automobile environment having limited ambient light such that the display is positioned between the user's eyes and the light guide panel element.

In implementations, the light guide may be produced by thermal forming the light guide ring and the light guide panel element as a single piece. In other implementations, the light guide may be produced by bonding the light guide ring to the light guide panel element using an optical bonding material or method. Both implementations result in producing a transparent light guide panel element that enables a user to view content or objects presented on the other side of the light guide panel element. In some embodiments, an optically clear adhesive layer is provided between the light guide panel element and display to reduce reflective leakage caused by a relatively high incidence angle.

Accordingly, described herein is a light guide having a transparent light guide panel element that may be incorporated into an electronic device to illuminate a display active area of a display without obstructing content or objects behind the light guide panel element. The light guide broadly includes a light source, a light guide panel element having a light input surface to receive light and a light output surface located proximate to the display active area, and a light guide ring shaped to substantially surround the light guide panel element and having at least one end located proximate to the light source. The light guide ring is shaped such that a significant portion of light from the light source enters the end(s) of the light guide ring and moves through the light guide ring around the light guide panel element. At least a portion of the light moving through the light guide ring moves into the light input surface of the light guide panel element and is redirected out the light output surface toward the display active area with a low angle of incidence. The light guide may thereby illuminate the display active area with increased efficiency, uniformity and decreased distance between light source and display active area. The light guide panel element may be positioned above or below the display active area. The shape of the light guide panel element may be similar to the shape of the display active area. The light source may be any suitable source of light, such as one or more LEDs. In some implementations, the light guide or at least a portion thereof may be coated with a material having a low refractive index material or a high reflectance material, which further increase efficiency.

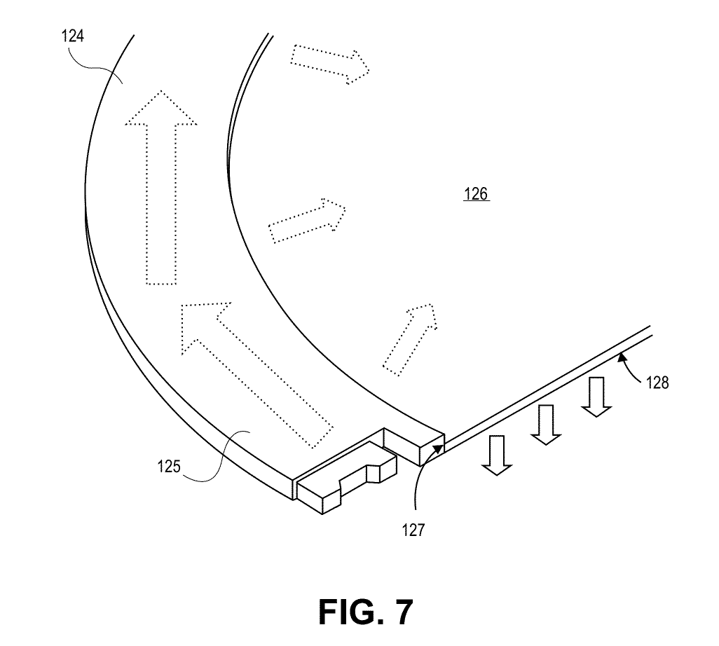

The light guide ring includes at least one end located proximate to the light source, and is shaped to substantially surround the light guide panel element. The light guide ring may be shaped such that light entering the light guide ring is directed into the end located proximate to the light source towards the end that is not located proximate to the light source. The path traveled by light received from the light source through the light guide ring and the width at a portion of the light guide ring may identify the end of the light guide ring that is located proximate to the light source and the end that is not located proximate to the light source. As shown in FIGS. 6 and 7, both ends of the light guide ring may be near the light source and light received by the light guide ring may travel substantially into the area near the end located proximate to the light source that has the greatest width and through the light guide ring until it reaches the other end, which may be separated from the light source using a gap.

The display active area may be positioned either above or below the light guide panel element, the perimeter of which is substantially enclosed by the light guide ring. In implementations, the light guide ring may have one end located proximate to the light source such that light enters that end and moves in substantially one direction through the light guide ring and around the display active area and light guide panel element. In another implementation, the light guide ring may have two ends located proximate to the light source such that light enters both ends and moves in substantially opposite directions through the light guide ring around the light guide panel element. For example, based on the shape of the light guide ring portion that is proximate to the light source, the light may move predominantly in the either the clockwise or counter-clockwise direction or the light may move in both the clockwise and counter-clockwise directions to uniformly illuminate the light guide ring, light guide panel element and the display active area positioned above or below the light guide panel element. The light generated by the light source may move through the light guide ring around the display panel element to entirely or substantially enclose the display panel element. Depending on the shape and construction of the light guide ring, light may move from the light guide ring into the light guide panel element or continue to travel through the light guide ring around the light guide panel element until it moves into the light guide panel element.

In implementations, the cross-section of the light guide ring may be substantially square or rectangular or round having a width or diameter ranging from approximately between 0.4 mm and 4 mm in width. For instance, the light guide ring may have a larger 4 mm width or diameter at a portion near the entry of light from the light source and a narrower 0.4 mm width or diameter at a tapered portion to provide uniform lighting by the light guide ring.

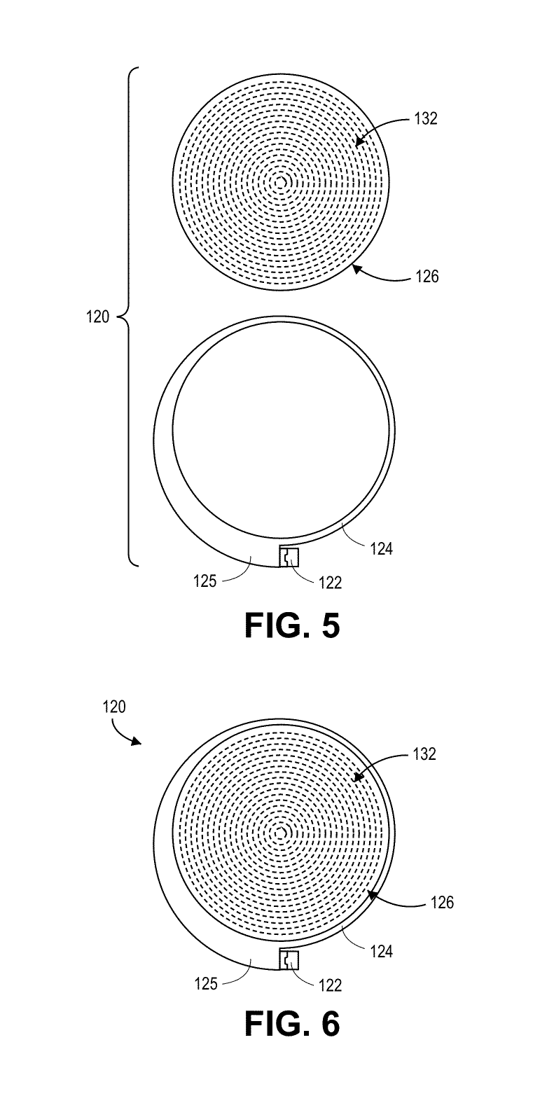

In embodiments, as shown in FIG. 5, approximately one-half of the light guide ring circumference may use the narrower width, such as 0.4 mm, and approximately one-half of the light guide ring circumference may use a width that gradually narrows or tapers from the widest point, such as 4 mm, to the narrower width. The thickness or height of the light guide ring may be substantially uniform or gradually taper with the width. In implementations, the light guide ring may have a height of less than 2 mm, such as 0.5 mm. The height of the light guide ring may also be equal to the thickness of light guide panel element.

In other implementations, the light guide ring may also be wedge-shaped, such that one or both of the cross-sectional dimensions are larger nearer to the light source and smaller farther from the light source to vary the light coupling efficiency around the light guide panel element and thereby achieve greater equalization of light coupling around the component. More specifically, the light guide ring may have a greater height (i.e., is thicker than) or be wider nearer to the light source at the surface where light is received from the light source in order to achieve a lower light coupling efficiency where the light is stronger, and may be thinner farther from the light source to achieve a higher light coupling efficiency where the light is weaker. For example, the light guide ring may have a greater height or thickness at the end located proximate to the light source than other portions of the light guide ring. In embodiments, the light guide ring may have a greater width at the end located proximate to the light source than other portions of the light guide ring.

Example materials from which the light guide ring may be made include polycarbonate and polymethylmethacrylate. The surface of the light guide ring may be uncoated, coated with a lower reflectance material (such as the structure of optical fiber), or coated with higher reflectance material (such as mirror). The light guide ring may be shaped such that light from the light source provides a uniform light source within the area enclosed by the light guide ring. As shown in FIGS. 5 and 6, this area may receive the light guide panel element.

The light guide panel element includes a light input surface located proximate to the light guide ring and a light output surface located proximate to the display active area. In embodiments, the light input surface may be a side, perimeter surface of the light guide panel element and the light output surface may be an upper or lower surface of the light guide panel element. In various implementations, the light guide panel element may be positioned above or below the display active area, such that light output from the light output surface may illuminate a display active area presenting content to a user. For example, a transparent light guide panel element positioned above a display active area enables users to view the content presented on the display through the light guide panel element.

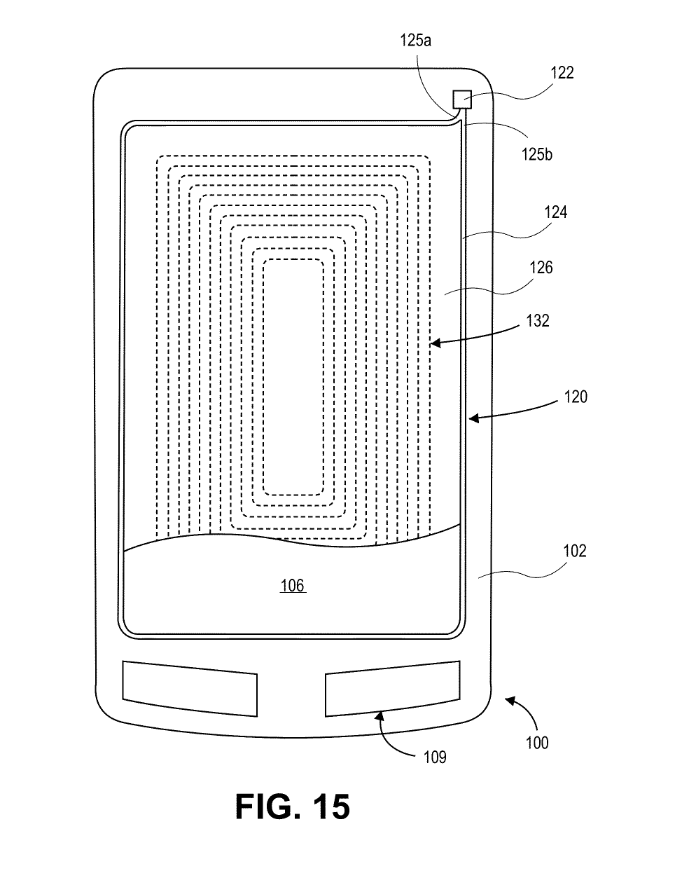

In various implementations, the light guide panel element may have a circular shape (e.g., disc, doughnut, etc.) or it may have a polygonal (e.g., triangular, rectangular, square, hexagon, etc.). The light guide panel element may have any shape that enables its light input surface to receive light from the light guide ring. For instance, as shown in FIG. 6, the perimeter of a circular light guide panel element may be enclosed by a light guide ring having an annular shape. Similarly, as shown in FIG. 15, the perimeter of a rectangular light guide panel element may be enclosed by a light guide ring having a rectangular shape. In embodiments, the light guide panel element may be oval, elliptical, or otherwise substantially polygonal with rounded corners and the light guide ring may be shaped to having an opening that allows the light guide panel element to receive light from the light guide ring and illuminate the display active area.

At least a portion of the light received from the light source through the light input surface moves into the light guide panel element, as the light moves through the light guide ring, and is redirected out of the light output surface of the light guide panel element toward the display with a low angle of incidence to illuminate the display active area. The thickness or height of the light guide panel element may be substantially uniform. In implementations, the light guide panel element may have a thickness ranging from approximately between 0.2 mm and 1 mm. The light guide panel element may take the form of a plate or a film. Similar to the light guide ring, example materials from which the light guide panel element may be made include polycarbonate and polymethylmethacrylate.

The light guide ring may further include relief structures to facilitate the movement of at least a portion of the light received from the light source through the light guide ring and into the light guide panel element. In implementations, the relief structures may be substantially U-shaped grooves. The relief structures may be substantially equally spaced around a perimeter of the ring; while in another implementation, the relief structures may be variably spaced around the perimeter of the ring to achieve greater equalization of light coupling around the light guide panel element. More specifically, the relief structures may be spaced farther apart nearer to the light source to achieve a lower light coupling efficiency where the light is stronger, and may be spaced closer together farther from the light source to achieve a higher light coupling efficiency where the light is weaker. The light guide ring may include a plurality of relief structures located adjacent to the light guide panel element and operable to facilitate movement of the light into the light input surface of the light guide panel element. For example, the plurality of relief structures are spaced around the light guide ring, and the spacing is substantially equal. The plurality of relief structures may be spaced around the light guide ring and, in implementations, the spacing is largest near the end located proximate to the light source. The described features of the wedge-shaped cross-section and the unequally spaced relief structures may be combined to achieve even greater equalization of light coupling around the light guide panel element.

The light guide panel element may further include light-extracting microstructures that function to redirect the light toward the display active area, which results in the reduced incidence angle at which light from the light source impinges upon the display active area. In implementations, the microstructures may take the form of, for example, grooves, prisms, printed diffusers, or other light extracting structures, that are patterned on the top and/or bottom surface of the light guide panel element and substantially concentric with the light guide ring. In another implementation, the microstructures may take the form of cones that are patterned on the top and/or bottom surface of the light guide panel element and randomly or non-randomly distributed thereabout. In yet another implementation, the microstructures may take the form of white dots covered by black dots, wherein the white dots diffuse the light toward the display active area and the black dots block the light from being diffused to the user (i.e., away from the display active area). In implementations, the dots may be 40 microns or smaller in size. In another implementation, the light guide panel may not include light-extracting microstructures, the light guide panel may be optically bonded onto reflective displays, for example e-paper display, so that the matt surface of the display pixels can be utilized as the light-extracting microstructure.

As described above, areas near a light source may have the appearance of a “hot spot” due to high intensity light in those areas. In some embodiments, the light guide may reduce a hot spot near a light source by interposing a groove or a gap between a portion of the light guide ring and the light source. For instance, portions of the light guide ring located proximate to the light source receives light from the light source may be shaped such that the light travels along the light guide ring to provide uniform illumination of the light guide ring, light guide panel element, and the display active area instead of outputting a high concentration of light near the light source. In embodiments, as shown in FIG. 5, the light guide ring may be shaped such that its width is greatest near the end located proximate to the light source and a gap is provided between the light source and the end that is not located proximate to the light source. Light received by the light guide ring may travel substantially into the area near the end located proximate to the light source that has the greatest width and through the light guide ring until it reaches the other end, which may be separated from the light source using a gap. The gap may be unfilled (i.e., an air gap) or filled with material, such as epoxy, plastic, or resin, that does not transmit light as well as the material of the light guide ring. In embodiments, a gap may be provided between the light source and the light guide panel element.

In some implementations, the light guide panel element may be positioned above the display between the display active area and a covering component, and an optical clear adhesive (OCA) film may be interposed between the upper surface of the light guide panel element and the lower surface of the covering component. The OCA may approximately fill any gaps between the former and the latter. OCA film may also be interposed between the upper surface of the display and the lower surface of the light guide panel element. In implementations where the light guide panel element is positioned below the display, the OCA film may be interposed between the upper surface of the light guide panel element and the lower surface of the display.

It will be appreciated that the light guide disclosed herein provides uniform illumination for the display active area, especially when using only a single light source, and a significantly smaller size than conventional light guides having a transparent light guide panel. This is accomplished in part by substantially enclosing the light guide panel element with a light guide ring, decreasing the incidence angle at which the light from the light source impinges upon the display active area, allowing for a shorter distance between the light guide ring and the light guide panel element illuminating the display active area, thereby reducing the overall size of the device. Additionally, a gap may minimize the immediate movement of high intensity light from the light source directly into portions of the light guide ring having reduced width, thereby avoiding a hot spot and further increasing the uniformity of illumination.

In the following discussion, an example mobile electronic device environment is described into which the light guide may be incorporated. It should be understood that this environment is merely illustrative and non-limiting, and that the light guide may be alternatively incorporated into a large variety of different environments.

### Example Environment

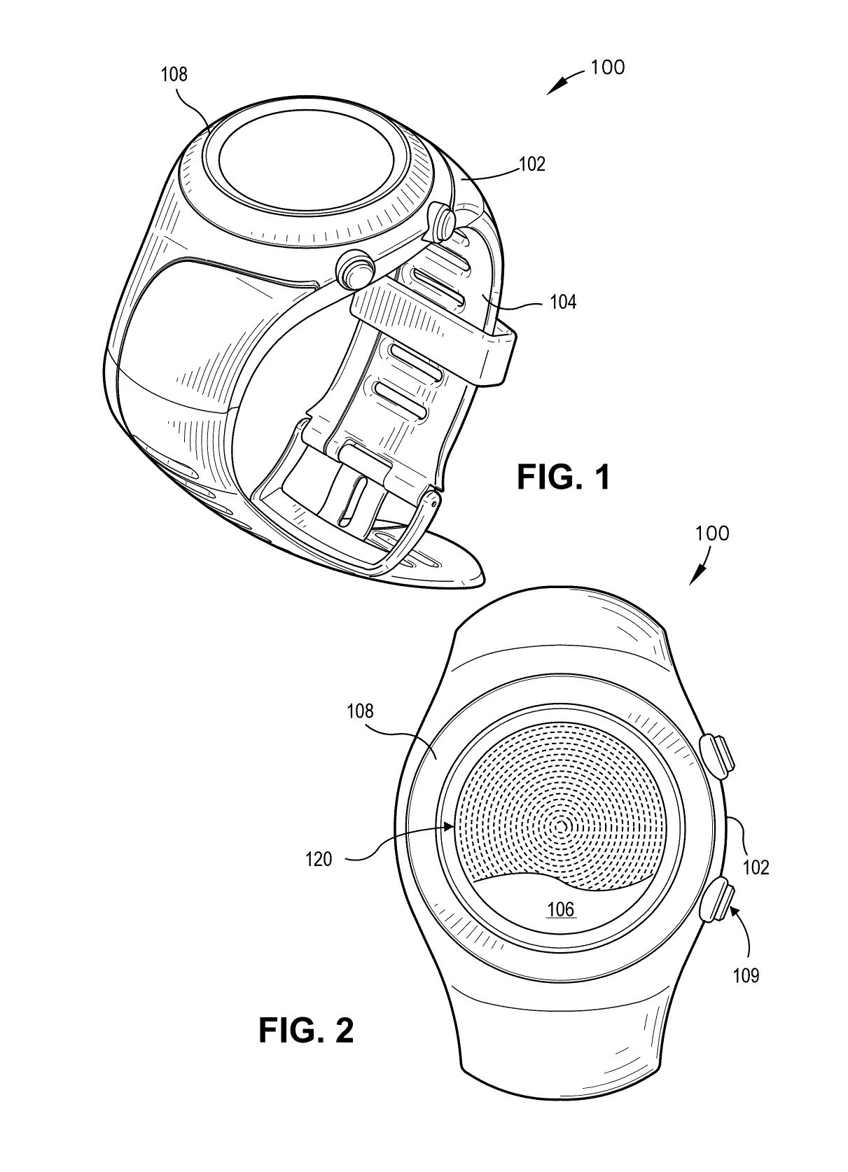

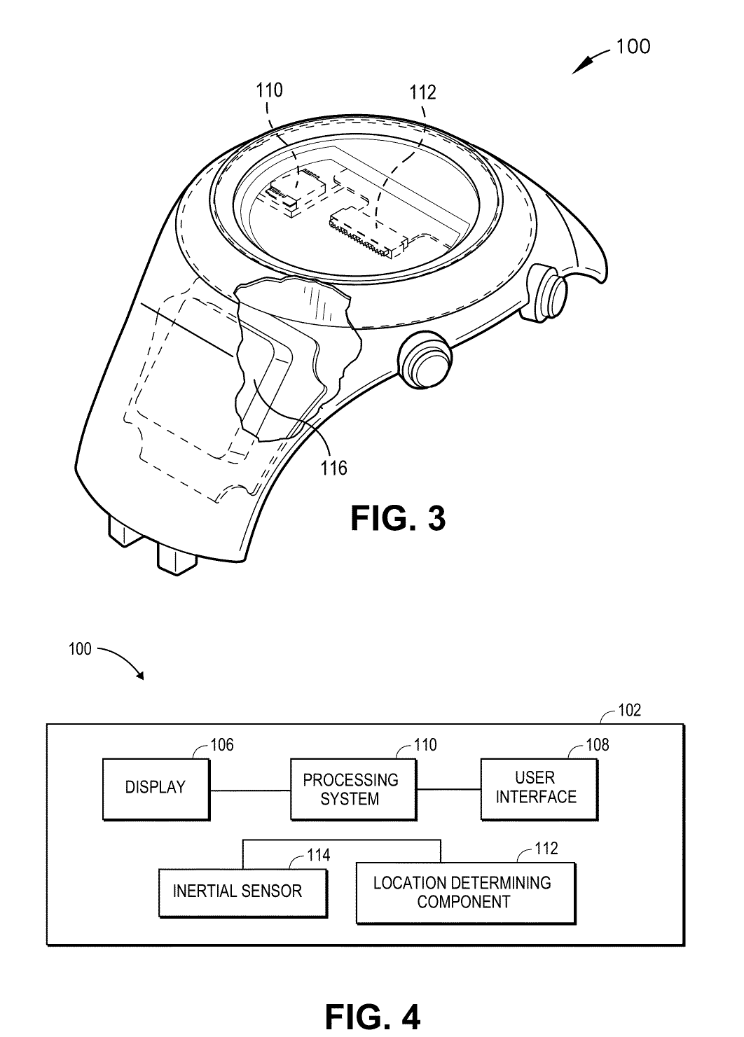

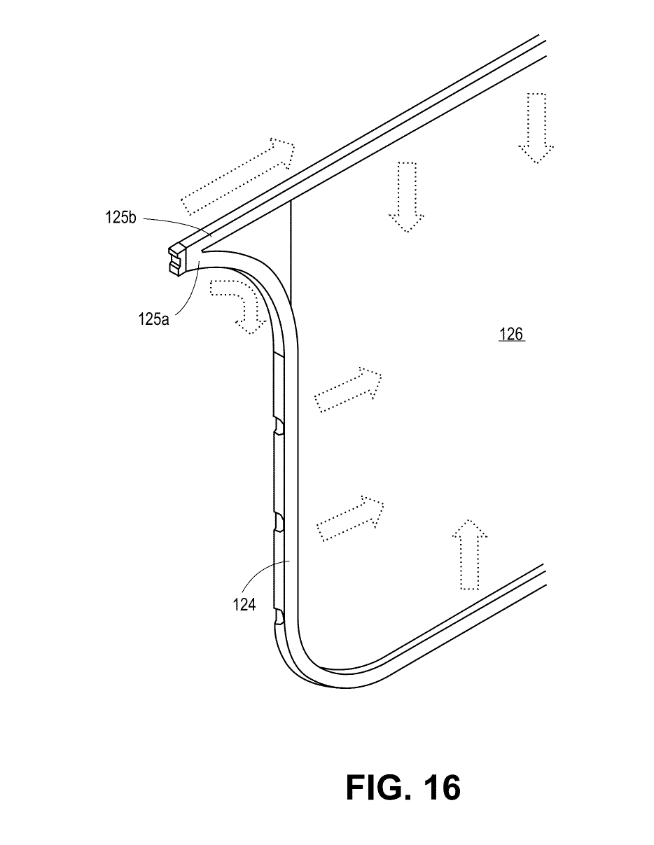

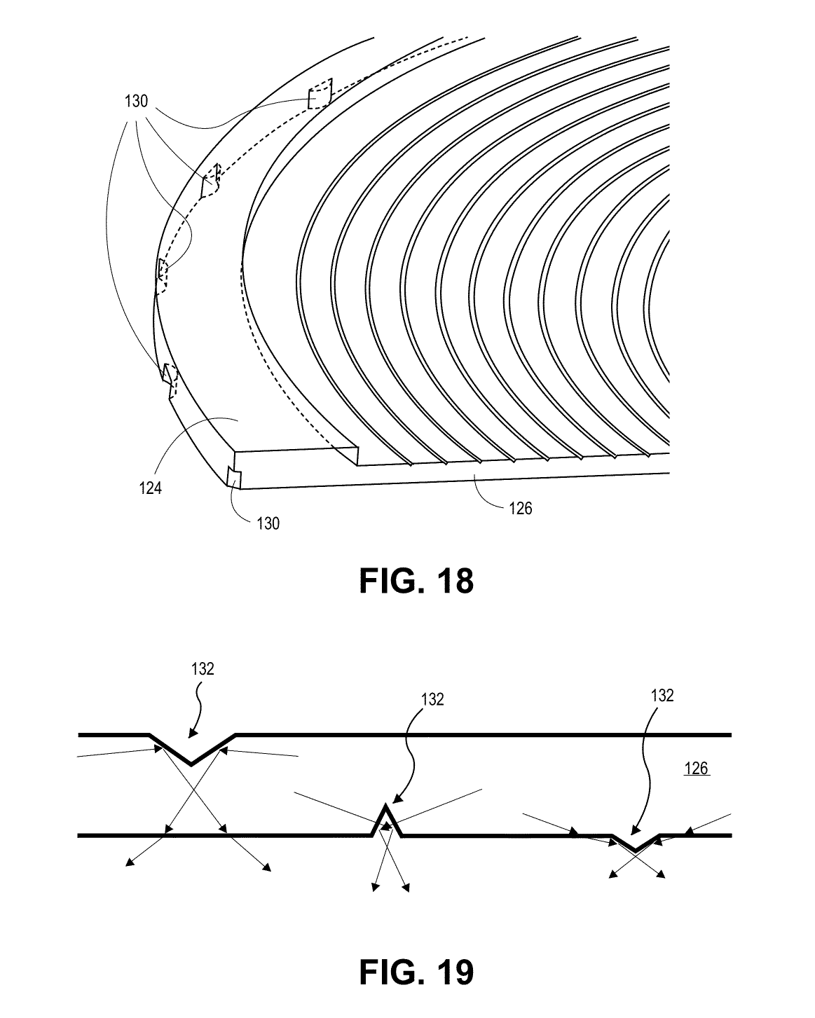

The example environment comprises a mobile electronic device operable to determine and report a user's geographic position. The mobile electronic device may take a large variety of different forms and shapes. For example, FIGS. 1-10, 14 and 18 depict an example first implementation of the mobile electronic device in the form of a watch having a substantially circular display active area, while FIGS. 15 and 16 depict an example second implementation of the device in the form of a hand-held having a rectangular display active area. It should be understood that the invention is not limited to either of these forms or shapes.

Referring to FIGS. 1-4, the device 100 may comprise a housing 102; a wristband 104 for securing the device 100 to a user's arm; a display 106 mounted in or integral to the housing 102 so that it may be viewed by the user while the device 100 is worn on the user's wrist; a touch-sensitive user interface 108 mounted proximate to the display 106 and/or one or more mechanical buttons 109 mounted on the housing 102 and operable to control the device's functionality; a processing system 110; a location-determining component 112; an inertial sensor 114; an antenna 116; and the light guide 120. The processing system 110 may be located within the housing 102, and may execute one or more software programs which control the presentation of information in the display active area of display 106 and the output and input of information via the user interface 108 and/or mechanical buttons 109. The location-determining component 112 may be located within the housing 102, and may be operable to determine the current geographic position of the device 100. As such, the location-determining component may 112 include a global positioning system (GPS) receiver or other Global Navigation Satellite system (GNSS) receiver or any other device which can determine the geographic location of the device 100, such as a cellular telephone receiver or a terrestrial navigation radio receiver. If a GPS receiver is included in the location-determining component 112, the GPS receiver may be operable to receive navigational signals from GPS satellites to calculate the geographic location of the device 100 as a function of the signals. The location-determining component 112 may at least periodically substantially automatically determine its current geographic location, and that location may be presented on the display 106 and/or stored within memory. The location-determining component 112 may also be operable to calculate a route to a desired location, provide instructions to navigate to the desired location, and display maps and other information on the display 106. The device 100 may further include a memory component associated with the processing system 110 and/or the location determining component 112, which may be operable to store cartographic data and routing used by or generated by the location-determining component 112. The inertial sensor 114 may be located within the housing 102, and may be operable to detect movement of the device 100 in order to determine a route of movement. The antenna 116 may be incorporated into or onto the housing 102, and may be operable to receive electronic signals, such as may be transmitted by the GPS satellites.

The device 100 may include various operating modes, such as a navigation mode that calculates navigation routes and other information using locations determined by the location-determining component 112. The processing system 110 may implement any one or more of a variety of useful functions, such as maintaining a track log representing various historical and current locations of the device 100, and/or identifying a route, such as a desired travel path, for the user and determining whether the user deviates from the identified route.

Referring to at least FIGS. 2, 5-7, and 15-17, the light guide 120 may be incorporated into the mobile electronic device 100 to illuminate the display active area of display 106. More specifically, the light guide 120 may be mounted proximate to display 106 to illuminate the display active area. As discussed, the light guide 120 may include a light source 122, a light guide panel element 126 having a light input surface 127 to receive light and a light output surface 128 located proximate to the display active area of display 106, and a light guide ring 124 shaped to substantially surround the light guide panel element 126 and having at least one end 125 located proximate to the light source 122. In operation, light generated by the light source 122 enters the at least one end 125 of the light guide ring 124 and moves through the light guide ring 124 around the perimeter of a light guide panel element 126 having a light output surface 128 located proximate to the display active area of display 106, and at least a portion of the light moving through the light guide ring 124 moves through the light input surface 127 into the light guide panel element 126 and is redirected out the light output surface 128 toward the display active area of display 106 with a low angle of incidence, thereby illuminating the display active area with increased efficiency and uniformity of light.

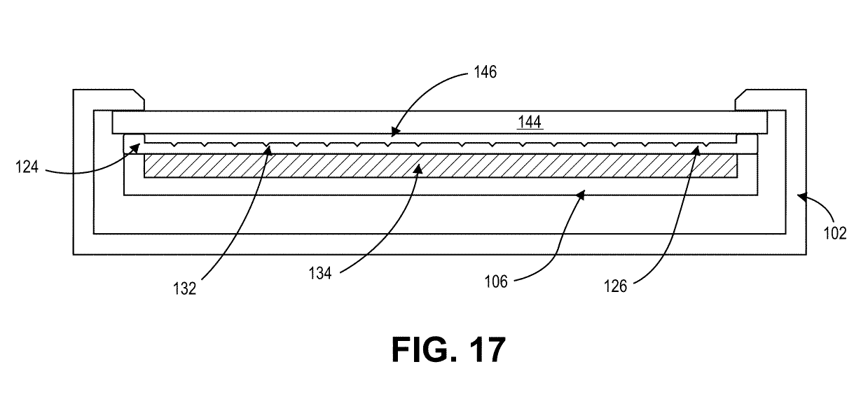

The light guide ring 124 includes the at least one end 125 located proximate to the light source 122, and is shaped to substantially surround the display active area and the perimeter of a light guide panel element 126. As shown in FIG. 17, light guide 120 is positioned over display active area 134 of display 106 such that the transparent light guide panel element 126 is positioned between the user's eyes and the display active area 134. The housing 102 may include an opening to provide an unobstructed view of the display active area 134. The covering component 144 may be positioned above the light guide panel element 126 to protect the light-extracting microstructures 132 from external elements and other elements within housing 102.

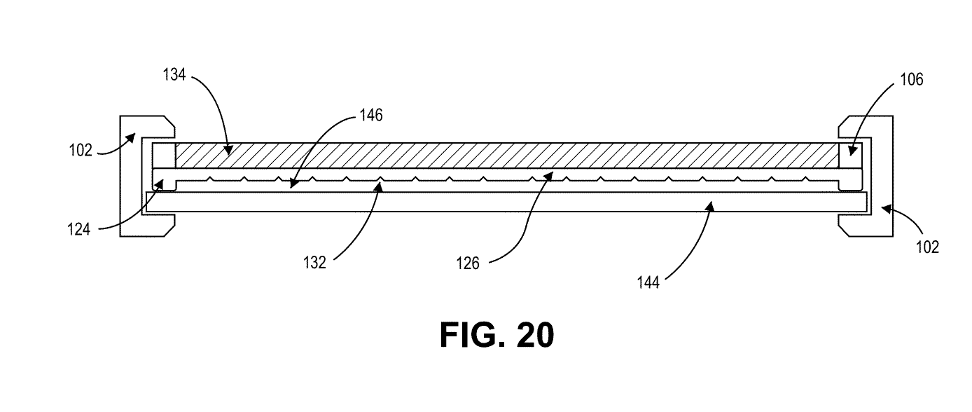

As described above, some displays 106 may be transparent. As shown in FIG. 20, in embodiments of the present invention, light guide 120 may be positioned under display 106 such that the display active area 134 of display 106 is positioned between the user's eyes and transparent light guide panel element 126. The housing 102 may include openings on both the front and back sides of the display 106 to provide an unobstructed view of the display active area 134 and objects present on the other side of the display 106. In embodiments, as shown in FIGS. 17 and 20, a display 106 positioned under a light guide panel element 126 may be thicker than a transparent display 106 positioned above a transparent light guide panel element 126. The covering component 144 may be positioned under the light guide panel element 126 to protect the light-extracting microstructures 132 from external elements and other elements within housing 102. In both embodiments, ambient light and light output by the light guide panel element 126 may pass through the display 106 to illuminate the display active area 134.

In implementations, as shown in FIGS. 2 and 5-7, the light guide ring 124 may have one end 125 located proximate to the light source 122 such that light enters that end 125 and moves in substantially one direction through the light guide ring 124 and around the light guide ring 124. The light guide ring 124 may be shaped such that the light received by the light guide ring may travel substantially into the one end 125 located proximate to the light source 122, which may have the greatest width along light guide ring 124, and through the light guide ring 124 until the light reaches the other end of the light guide ring 124 to uniformly illuminate light guide ring 124. The other end of the light guide ring 124 may be separated from the light source using a gap. As shown in FIG. 14, the light guide 120 may further include a groove or other gap 140 interposed between the light guide ring 124 and the light source 122 to minimize the appearance of a “hot spot” due to high intensity light moving immediately through the light guide ring 124 into the light guide panel element 126. In another implementation shown in FIGS. 15 and 16, the light guide ring 124 may have two ends 125a, 125b located proximate to the light source 122 such that light enters both ends 125a, 125b and moves in substantially opposite directions through the light guide ring 124 around the transparent light guide panel element 126, which is positioned proximate to the display active area of display 106.

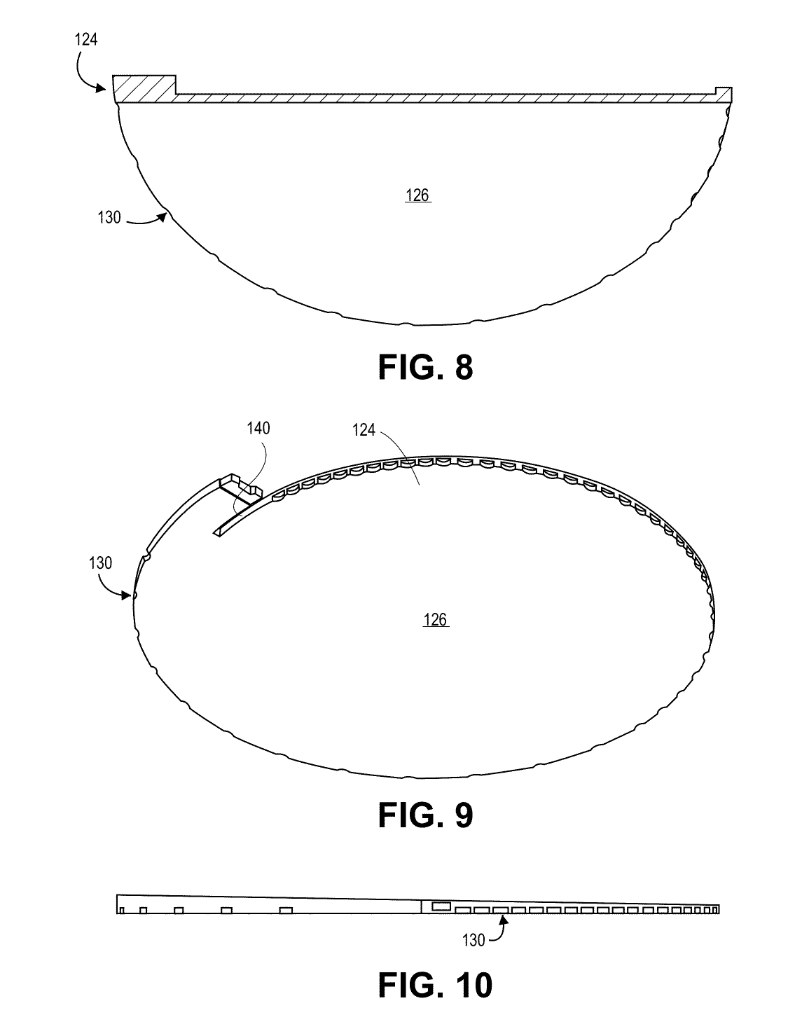

In implementations, as shown in FIGS. 8-10 and 18, the light guide ring 122 may also be wedge-shaped such that one or both of the cross-sectional dimensions are larger nearer to the light source 122 and smaller farther from the light source 122 to vary the light coupling efficiency around the light guide panel element 126 and thereby achieve greater equalization of light coupling around the light guide panel element 126. The gradual tapering of the light guide ring 124 helps provide uniform light output by the light guide ring 124. More specifically, the light guide ring 124 may be thicker nearer to the light source 122 to achieve a lower light coupling efficiency where the light is stronger, and may be thinner farther from the light source 122 to achieve a higher light coupling efficiency where the light is weaker.

As shown in FIGS. 8-10 and 18, the light guide ring 124 may include relief structures 130 to facilitate the movement of at least a portion of the light from the light guide ring 124 into the light guide panel element 126. The relief structures 130 may be variably spaced around the light guide panel element 126, being spaced farther apart nearer to the light source 122 and spaced closer together farther from the light source 122. In embodiments, the height of the relief structures 130 may be equal to or lesser than the thickness of the light guide panel element 126.

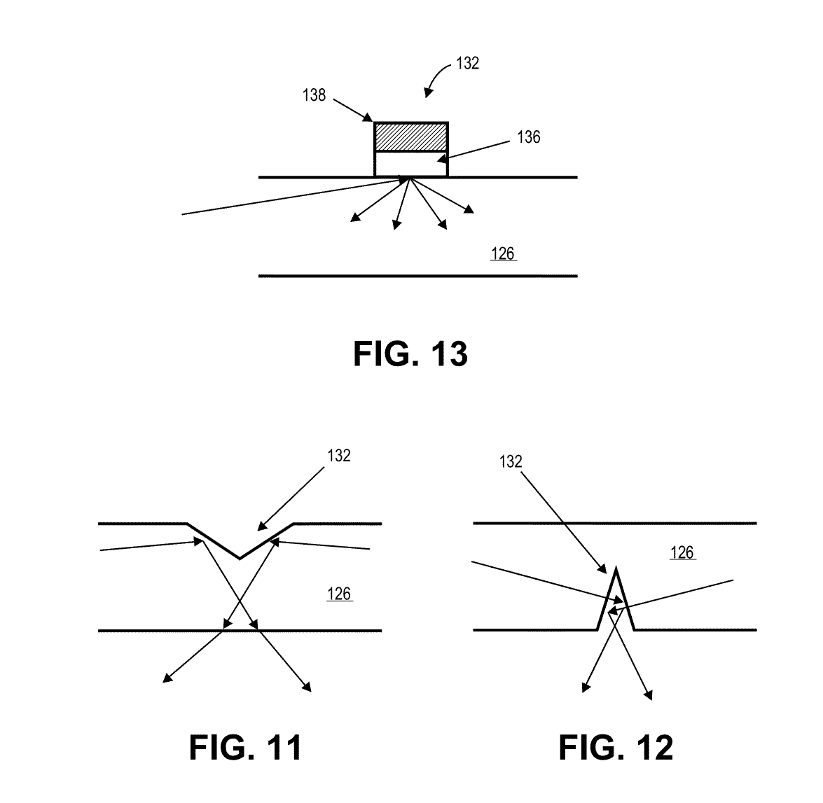

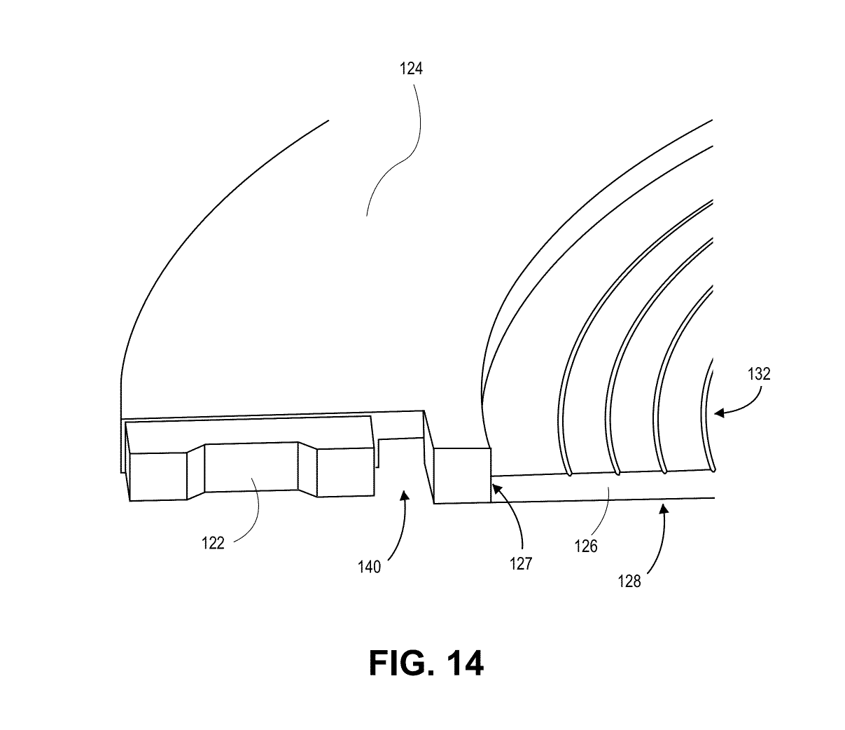

As shown in, FIGS. 2 and 15, the light guide panel element 126 may include a plurality of light-extracting microstructures 132 that function to redirect light output from the light output surface 128 toward the display active area of display 106, which results in a reduced incidence angle at which light from the light source 122 impinges upon the display active area. In implementations, as shown in FIGS. 11-13 and 19, the microstructures 132 may take the form of, for example, grooves, prisms, printed diffusers, or other light extracting structures, that are patterned on the light output surface 128 or a surface opposite to the light output surface 128 of the light guide panel element 126 and substantially concentric with the light guide ring 124. For example, as shown in FIG. 12, the microstructures 132 may take the form of cones that are patterned on the light output surface 128 or a surface opposite to the light output surface 128 of the light guide panel element 126 and randomly or non-randomly distributed thereabout. In another example, as shown in FIG. 13, the microstructures 132 may take the form of white dots 136 covered by black dots 138, wherein the white dots 136 diffuse the light toward the display active area and the black dots 138 block the light from being diffused to the user (i.e., away from the display active area of display 106). In yet another example, as shown in FIG. 19, a plurality of microstructures 132 may be located on two surfaces of light guide panel element 126. For example, the microstructures 132 may be located on the top and bottom surfaces of light guide panel element 126. One or more of the microstructures 132 may protrude out of the surface of the light guide panel element 126 while other microstructures 132 may sink into the surface of the light guide panel element 126.

In implementations, as shown in FIG. 17, the light guide 120 may be positioned between the display 106 and a covering component 144. At least a portion of the light guide ring 124 may be positioned over the display 106 for structural support. An optical clear adhesive (OCA) film 146 may be interposed between the upper surface of the light guide panel element 126 and the lower surface of the covering component 144. The OCA film 146 may approximately fill the gap between the former and the latter; however, the OCA film 146 may not fill the microstructures 132 patterned on the light guide panel element 126. It should be understood that, in embodiments, the display 106 may be positioned between the light guide 120 and the covering component 144.

### CONCLUSION

Although the light guide has been described with reference to various possible embodiments, implementations, features, and example environments, it is to be understood that the claims are not necessarily limited to these or any other specific embodiments, implementations, features, or example embodiments.

What is claimed is:

1. A mobile electronic device comprising:
a display having a display active area;
a light guide operable to illuminate the display active area, the light guide including—
a light source;
a light guide panel element having a light input surface to receive light and a light output surface located proximate to the display active area; and
a light guide ring shaped to substantially surround the light guide panel element and having at least one end located proximate to the light source;
wherein the light guide ring is shaped such that a significant portion of light from the light source enters the end of the light guide ring and moves through the light guide ring around the light guide panel element, and
wherein at least a portion of the light moving through the light guide ring moves into the light input surface of the light guide panel element and is redirected out the light output surface toward the display active area.

2. The mobile electronic device as set forth in claim 1, wherein the light guide panel element is transparent.

3. The mobile electronic device as set forth in claim 1, wherein the light guide ring guides at least some of the light in one direction around the light guide panel element.

4. The mobile electronic device as set forth in claim 1, wherein the light guide ring guides the light in opposite directions around the light guide panel element.

5. The mobile electronic device as set forth in claim 1, wherein the light guide ring has an overall shape that is substantially annular.

6. The mobile electronic device as set forth in claim 1, wherein the light guide ring has an overall shape that is substantially polygonal.

7. The mobile electronic device as set forth in claim 1, wherein the light guide ring has a cross-sectional area that is larger at the end located proximate to the light source.

8. The mobile electronic device as set forth in claim 7, wherein the light guide ring has a greater height at the end located proximate to the light source than other portions of the light guide ring.

9. The mobile electronic device as set forth in claim 1, wherein the light guide ring includes a plurality of relief structures on a surface is the opposite to the light input surface of the light guide panel element and operable to facilitate movement of the light into the light input surface of the light guide panel element.

10. The mobile electronic device as set forth in claim 8, wherein the spacing of the relief structures is largest near the end located proximate to the light source.

11. The mobile electronic device as set forth in claim 1, further including a gap between the light source and the light guide ring.

12. The mobile electronic device as set forth in claim 1, wherein the light guide panel element is positioned above the display.

13. The mobile electronic device as set forth in claim 12, further comprising a covering component, wherein the light guide is positioned below the covering component.

14. The mobile electronic device as set forth in claim 1, wherein the light guide panel element is positioned below the display.

15. The mobile electronic device as set forth in claim 1, wherein the light input surface is a side surface of the light guide panel element and the light output surface is an upper or lower surface of the light guide panel element.

16. A mobile electronic device comprising:
a display having a display active area;
a light guide operable to illuminate the display active area, the light guide including—
a light source;
a transparent light guide panel element having a light input surface to receive light, a light output surface located proximate to the display active area, and a plurality of microstructures; and
a light guide ring shaped to substantially surround the light guide panel element and having an end located proximate to the light source;
wherein the light guide ring is shaped such that a significant portion of light from the light source enters the end of the light guide ring and moves in one direction through the light guide ring around the light guide panel element, and
wherein at least a portion of the light moving through the light guide ring moves into the light input surface of the light guide panel element and the microstructures redirect the light out the light output surface toward the display active area.

17. The mobile electronic device as set forth in claim 16, wherein the light guide ring has a cross-sectional area that is larger at the end located proximate to the light source.

18. The mobile electronic device as set forth in claim 16, further comprising a covering component positioned above the light guide panel element and the light guide panel element is positioned above the display.

20. A mobile electronic device comprising:
a display having a display active area;
a light guide operable to illuminate the display active area, the light guide including—
a light source;
a transparent light guide panel element having a light input surface to receive light, a light output surface located proximate to the display active area, and a plurality of microstructures; and
a light guide ring shaped to substantially surround the light guide panel element and having first and second ends located proximate to the light source;
wherein the light guide ring is shaped such that a significant portion of light from the light source enters the first and second ends of the light guide ring and moves in opposite directions through the light guide ring around the light guide panel element, and
wherein at least a portion of the light moving through the light guide ring moves into the light input surface of the light guide panel element and the microstructures redirect the light out the light output surface toward the display active area with a low angle of incidence.
